(19) United States
(12) Patent Application Publication
(10) Pub. No.: US 2020/0286094 A1
(43) Pub. Date: Sep. 10, 2020

(54) System, Method, and Apparatus for Determining a Geo-Location of a Transaction

(71) Applicant: Visa International Service Association, San Francisco, CA (US)

(72) Inventors: Animesh Mishra, Kanpur (IN); Soumyajyoti Banerjee, Howrah (IN)

(21) Appl. No.: 16/405,079

(22) Filed: May 7, 2019

Related U.S. Application Data
(60) Provisional application No. 62/813,317, filed on Mar. 4, 2019.

(51) Int. Cl. G06Q 20/40; G06F 16/29; G06N 20/00

(52) U.S. Cl. CPC G06Q 20/4016; G06N 20/00; G06F 16/29

(57) ABSTRACT

Disclosed is a method for determining a street address based on transaction data. The method may include receiving transaction data associated with a payment transaction, determining street address data from the transaction data, tokenizing the street address data into a plurality of street address tokens, extracting street address token features for each street address token using a machine learning algorithm, tagging each of the street address tokens using the machine learning algorithm based on the street address token features to provide a plurality of tagged street address components, determining whether each of the tagged street address components correspond to a predetermined street address, and communicating a payment transaction fraud parameter. A system and a computer program product are also provided.

### CROSS REFERENCE TO RELATED APPLICATION

This application claims the benefit of U.S. Provisional Application No. 62/813,317, filed on Mar. 4, 2019, the entire content of which is hereby incorporated by reference.

### BACKGROUND

### 1. Field

This disclosure relates generally to geo-location detection and, in one non-limiting embodiment, to a system, method, and apparatus for determining a street address based on transaction data.

### 2. Technical Considerations

Detecting fraudulent transactions can be technically challenging for interested entities such as, for example, banks, merchants, payment gateways, electronic wallets, verification services, and/or the like. These interested entities may use systems such as an Address Verification System (AVS) to verify that certain address information received during a transaction matches known address information for one or more parties to the transaction. For example, the AVS may receive a purported address for a merchant account and, from the purported address, identify an address number and a zip code. The address number and zip code are then compared to a known address number and zip code associated with the merchant account. However, presently, systems do not exist which are able to verify an address based on additional address information.

### SUMMARY

In non-limiting embodiments, provided is a computer-implemented method for determining a street address based on transaction data, including: receiving, with at least one processor, transaction data associated with a payment transaction; determining, with at least one processor, street address data associated with a street address from the transaction data associated with the payment transaction; tokenizing, with at least one processor, the street address data associated with the street address into a plurality of street address tokens; extracting, with at least one processor, street address token features for each of the plurality of street address tokens using a machine learning algorithm; tagging, with at least one processor, each of the plurality of street address tokens using the machine learning algorithm based on the street address token features to provide a plurality of tagged street address components; determining, with at least one processor, whether each of the plurality of tagged street address components correspond to a plurality of predetermined street address components; and communicating, with at least one processor, an indication of a payment transaction fraud parameter based on determining whether each of the plurality of tagged street address components correspond to the plurality of predetermined street address components.

In some non-limiting embodiments, receiving the transaction data associated with the payment transaction includes: receiving a payment transaction message including the transaction data associated with the payment transaction, wherein determining the street address data associated with the street address from the transaction data associated with the payment transaction includes: determining the street address data with the street address from a merchant name field of the payment transaction message.

In some non-limiting embodiments, determining whether each of the plurality of tagged street address components correspond to the plurality of predetermined street address components includes: determining whether each of the plurality of tagged street address components correspond to the plurality of predetermined street address components based on a combination of exact and native approximate string matching techniques.

In some non-limiting embodiments, the method may further include standardizing the plurality of street address tokens before extracting the street address token features for each of the plurality of street address tokens. In some non-limiting embodiments, the method may further include assigning the indication of a payment transaction fraud parameter to the payment transaction based on determining that each of the plurality of tagged street address components do not correspond to the plurality of predetermined street address components; and wherein communicating the indication of a payment transaction fraud parameter includes: communicating the indication of a payment transaction fraud parameter based on assigning the indication of a payment transaction fraud parameter to the payment transaction.

In some non-limiting embodiments, determining the street address data associated with the street address from the transaction data associated with the payment transaction comprises: determining the street address data associated with the street address of a point-of-sale (POS) terminal from the transaction data associated with the payment transaction.

In some non-limiting embodiments, the method further includes communicating street address data associated with a street address of a merchant based on determining that each of the plurality of tagged street address components correspond to the plurality of predetermined street address components.

In some non-limiting embodiments, extracting the street address token features for each of the plurality of street address tokens using the machine learning algorithm includes: determining a value of a first street address token; and determining a value of a second street address token, wherein the second street address token is adjacent to the first street address token.

In some non-limiting embodiments, extracting the street address token features for each of the plurality of street address tokens using the machine learning algorithm includes: determining if a first street address token corresponds to a direction of a street address; determining if a second street address token corresponds to a street type of a street address; and determining if a third street address token corresponds to an occupancy type of a street address.

In non-limiting embodiments, provided is a system for determining a street address based on transaction data, including at least one server computer having at least one processor, the at least one server computer programmed or configured to: receive transaction data associated with a payment transaction; determine street address data associated with a street address from the transaction data associated with the payment transaction; tokenize the street address data associated with the street address into a plurality of street address tokens; extract street address token features for each of the plurality of street address tokens using a machine learning algorithm; tag each of the plurality of street address tokens using the machine learning algorithm based on the street address token features to provide a plurality of tagged street address components; determine whether each of the plurality of tagged street address components correspond to a plurality of predetermined street address components; and communicate an indication of a payment transaction fraud parameter based on determining whether each of the plurality of tagged street address components correspond to the plurality of predetermined street address components.

In some non-limiting embodiments, receiving the transaction data associated with the payment transaction includes: receiving a payment transaction message comprising the transaction data associated with the payment transaction, wherein determining the street address data associated with the street address from the transaction data associated with the payment transaction includes: determining the street address data with the street address from a merchant name field of the payment transaction message. In some non-limiting embodiments, determining whether each of the plurality of tagged street address components correspond to the plurality of predetermined street address components includes: determining whether each of the plurality of tagged street address components correspond to the plurality of predetermined street address components based on a combination of exact and native approximate string matching techniques. In some non-limiting embodiments, the at least one server computer is further programmed or configured to: standardize the plurality of street address tokens before extracting the street address token features for each of the plurality of street address tokens.

In some non-limiting embodiments, the at least one server computer may be further programmed or configured to: assign the indication of a payment transaction fraud parameter to the payment transaction based on determining that each of the plurality of tagged street address components do not correspond to the plurality of predetermined street address components. Communicating the indication of a payment transaction fraud parameter may include: communicating the indication of a payment transaction fraud parameter based on assigning the indication of a payment transaction fraud parameter to the payment transaction.

In some non-limiting embodiments, determining the street address data associated with the street address from the transaction data associated with the payment transaction may include: determining the street address data associated with the street address of a POS terminal from the transaction data associated with the payment transaction. In some non-limiting embodiments, the at least one server computer may be further programmed or configured to: communicate street address data associated with a street address of a merchant based on determining that each of the plurality of tagged street address components correspond to the plurality of predetermined street address components.

In some non-limiting embodiments, extracting the street address token feature for each of the plurality of street address tokens using the machine learning algorithm may include: determining a value of a first street address token; and determining a value of a second street address token, wherein the second street address token is adjacent to the first street address token. In some non-limiting embodiments, extracting the street address token feature for each of the plurality of street address tokens using the machine learning algorithm may include: determining if a first street address token corresponds to a direction of a street address; determining if a second street address token corresponds to a street type of a street address; and determining if a third street address token corresponds to an occupancy type of a street address.

In non-limiting embodiments, a computer program product for determining a street address based on transaction data is provided, the computer program product including at least one non-transitory computer-readable medium having program instructions that, when executed by at least one processor, cause the at least one processor to: receive transaction data associated with a payment transaction; determine street address data associated with a street address from the transaction data associated with the payment transaction; tokenize the street address data associated with the street address into a plurality of street address tokens; extract street address token features for each of the plurality of street address tokens using a machine learning algorithm; tag each of the plurality of street address tokens using the machine learning algorithm based on the street address token features to provide a plurality of tagged street address components; determine whether each of the plurality of tagged street address components correspond to a plurality of predetermined street address components; and communicate an indication of a payment transaction fraud parameter based on determining whether each of the plurality of tagged street address components correspond to the plurality of predetermined street address components.

In some non-limiting embodiments, extracting the street address token feature for each of the plurality of street address tokens using the machine learning algorithm includes: determining a value of a first street address token; and determining a value of a second street address token, wherein the second street address token is adjacent to the first street address token.

Further embodiments or aspects are set forth in the following numbered clauses:

Clause 1. A method for determining a street address based on transaction data, comprising: receiving, with at least one processor, transaction data associated with a payment transaction; determining, with at least one processor, street address data associated with a street address from the transaction data associated with the payment transaction; tokenizing, with at least one processor, the street address data associated with the street address into a plurality of street address tokens; extracting, with at least one processor, street address token features for each of the plurality of street address tokens using a machine learning algorithm; tagging, with at least one processor, each of the plurality of street address tokens using the machine learning algorithm based on the street address token features to provide a plurality of tagged street address components; determining, with at least one processor, whether each of the plurality of tagged street address components correspond to a plurality of predetermined street address components; and communicating, with at least one processor, an indication of a payment transaction fraud parameter based on determining whether each of the plurality of tagged street address components correspond to the plurality of predetermined street address components.

Clause 2. The method of clause 1, wherein receiving the transaction data associated with the payment transaction comprises: receiving a payment transaction message comprising the transaction data associated with the payment transaction, wherein determining the street address data associated with the street address from the transaction data associated with the payment transaction comprises: determining the street address data with the street address from a merchant name field of the payment transaction message.

Clause 3. The method of clauses 1 or 2, wherein determining whether each of the plurality of tagged street address components correspond to the plurality of predetermined street address components comprises: determining whether each of the plurality of tagged street address components correspond to the plurality of predetermined street address components based on a combination of exact and native approximate string matching techniques.

Clause 4. The method of any of clauses 1-3, further comprising: standardizing the plurality of street address tokens before extracting the street address token features for each of the plurality of street address tokens.

Clause 5. The method of any of clauses 1-4, further comprising: assigning the indication of a payment transaction fraud parameter to the payment transaction based on determining that each of the plurality of tagged street address components do not correspond to the plurality of predetermined street address components; and wherein communicating the indication of a payment transaction fraud parameter comprises: communicating the indication of a payment transaction fraud parameter based on assigning the indication of a payment transaction fraud parameter to the payment transaction.

Clause 6. The method of any of clauses 1-5, wherein determining the street address data associated with the street address from the transaction data associated with the payment transaction comprises: determining the street address data associated with the street address of a point-of-sale (POS) terminal from the transaction data associated with the payment transaction.

Clause 7. The method of any of clauses 1-6, further comprising: communicating street address data associated with a street address of a merchant based on determining that each of the plurality of tagged street address components correspond to the plurality of predetermined street address components.

Clause 8. The method of any of clauses 1-7, wherein extracting the street address token features for each of the plurality of street address tokens using the machine learning algorithm comprises: determining a value of a first street address token; and determining a value of a second street address token, wherein the second street address token is adjacent the first street address token.

Clause 9. The method of any of clauses 1-8, wherein extracting the street address token features for each of the plurality of street address tokens using the machine learning algorithm comprises: determining if a first street address token corresponds to a direction of a street address; determining if a second street address token corresponds to a street type of a street address; and determining if a third street address token corresponds to an occupancy type of a street address.

Clause 10. A system for determining a street address based on transaction data, comprising at least one server computer including at least one processor, the at least one server computer programmed or configured to: receive transaction data associated with a payment transaction; determine street address data associated with a street address from the transaction data associated with the payment transaction; tokenize the street address data associated with the street address into a plurality of street address tokens; extract street address token features for each of the plurality of street address tokens using a machine learning algorithm; tag each of the plurality of street address tokens using the machine learning algorithm based on the street address token features to provide a plurality of tagged street address components; determine whether each of the plurality of tagged street address components correspond to a plurality of predetermined street address components; and communicate an indication of a payment transaction fraud parameter based on determining whether each of the plurality of tagged street address components correspond to the plurality of predetermined street address components.

Clause 11. The system of clause 10, wherein receiving the transaction data associated with the payment transaction comprises: receiving a payment transaction message comprising the transaction data associated with the payment transaction, wherein determining the street address data associated with the street address from the transaction data associated with the payment transaction comprises: determining the street address data with the street address from a merchant name field of the payment transaction message.

Clause 12. The system of clauses 10 or 11, wherein determining whether each of the plurality of tagged street address components correspond to the plurality of predetermined street address components comprises: determining whether each of the plurality of tagged street address components correspond to the plurality of predetermined street address components based on a combination of exact and native approximate string matching techniques.

Clause 13. The system of any of clauses 10-12, wherein the at least one server computer is further programmed or configured to: standardize the plurality of street address tokens before extracting the street address token features for each of the plurality of street address tokens.

Clause 14. The system of claim any of clauses 10-13, wherein the at least one server computer is further programmed or configured to: assign the indication of a payment transaction fraud parameter to the payment transaction based on determining that each of the plurality of tagged street address components do not correspond to the plurality of predetermined street address components; and wherein communicating the indication of a payment transaction fraud parameter comprises: communicating the indication of a payment transaction fraud parameter based on assigning the indication of a payment transaction fraud parameter to the payment transaction.

Clause 15. The system of any of clauses 10-14, wherein determining the street address data associated with the street address from the transaction data associated with the payment transaction comprises: determining the street address data associated with the street address of a point-of-sale (POS) terminal from the transaction data associated with the payment transaction.

Clause 16. The system of any of clauses 10-15, wherein the at least one server computer is further programmed or configured to: communicate street address data associated with a street address of a merchant based on determining that each of the plurality of tagged street address components correspond to the plurality of predetermined street address components.

Clause 17. The system of any of clauses 10-16, wherein extracting the street address token feature for each of the plurality of street address tokens using the machine learning algorithm comprises: determining a value of a first street address token; and determining a value of a second street address token, wherein the second street address token is adjacent to the first street address token.

Clause 18. The system of any of clauses 10-17, wherein extracting the street address token feature for each of the plurality of street address tokens using the machine learning algorithm comprises: determining if a first street address token corresponds to a direction of a street address; determining if a second street address token corresponds to a street type of a street address; and determining if a third street address token corresponds to an occupancy type of a street address.

Clause 19. A computer program product for determining a street address based on transaction data, comprising at least one non-transitory computer-readable medium including program instructions that, when executed by at least one processor, cause the at least one processor to: receive transaction data associated with a payment transaction; determine street address data associated with a street address from the transaction data associated with the payment transaction; tokenize the street address data associated with the street address into a plurality of street address tokens; extract street address token features for each of the plurality of street address tokens using a machine learning algorithm; tag each of the plurality of street address tokens using the machine learning algorithm based on the street address token features to provide a plurality of tagged street address components; determine whether each of the plurality of tagged street address components correspond to a plurality of predetermined street address components; and communicate an indication of a payment transaction fraud parameter based on determining whether each of the plurality of tagged street address components corresponds to the plurality of predetermined street address components.

Clause 20. The computer program product of clause 19, wherein extracting the street address token feature for each of the plurality of street address tokens using the machine learning algorithm comprises: determining a value of a first street address token; and determining a value of a second street address token, wherein the second street address token is adjacent to the first street address token.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a schematic diagram of a system for determining a street address based on transaction data according to a non-limiting embodiment;

FIG. 2 is a diagram of a non-limiting embodiment of components of one or more devices of FIG. 1;

FIG. 3 is a flow diagram of a process for determining a street address based on received address data according to a non-limiting embodiment; and

FIGS. 4A and 4B are diagrams of an implementation of a non-limiting embodiment of a process shown in FIG. 3.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the illustrated embodiments are not to be interpreted as limiting and may assume various alternative variations and step sequences, except where expressly specified to the contrary. It is also to be understood that the specific devices and processes illustrated in the attached drawings, and described in the following specification, are simply exemplary embodiments or aspects of the present disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

As used herein, the term “communicate” may refer to the reception, receipt, transmission, transfer, provision, and/or the like of information (e.g., data, signals, messages, instructions, commands, and/or the like). As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments, a message may refer to a packet (e.g., a data packet, a network packet, and/or the like) that includes data.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments, a transaction service provider system may include one or more servers operated by or operated on behalf of a transaction service provider.

As used herein, the term “issuer” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions). For example, an issuer may provide an account identifier, such as a primary account number (PAN), to a user that uniquely identifies one or more accounts associated with the user. The account identifier may be used by the user to conduct a payment transaction. In some non-limiting embodiments, the account identifier may be embodied on a portable financial device, such as a physical financial instrument (e.g., a payment card) and/or may be electronic and used for electronic payments. In some non-limiting embodiments, an issuer may be associated with a bank identification number (BIN) that uniquely identifies the issuer. As used herein “issuer system” may refer to one or more systems operated by or operated on behalf of an issuer. For example, an issuer system may refer to a server executing one or more software applications associated with the issuer. In some non-limiting embodiments, an issuer system may include one or more servers (e.g., one or more authorization servers) for authorizing a payment transaction.

As used herein, the term “merchant” may refer to one or more entities (e.g., one or more operators of retail businesses, one or more retailers, and/or the like) that provide goods and/or services to a user based on a payment transaction between the one or more entities and the user. As used herein “merchant system” may refer to one or more systems operated by or operated on behalf of a merchant, such as a server executing one or more software applications associated with the merchant.

As used herein, the term “account identifier” may refer to one or more types of identifiers associated with an account (e.g., a unique identifier of an account, an account number, a PAN, a card number, a payment card number, a token, and/or the like) of a user. In some non-limiting embodiments, an issuer may provide an account identifier to a user that uniquely identifies one or more accounts associated with that user. In some non-limiting embodiments, an account identifier may be embodied on a physical financial instrument (e.g., a portable financial device, a payment card, a credit card, a debit card, and/or the like) and/or may be electronic information communicated to the user that the user may use for electronic payment transactions. In some non-limiting embodiments, an account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments, an account identifier may be directly or indirectly associated with an issuer such that an account identifier may be a token that maps to a PAN or other type of identifier. Account identifiers may be alphanumeric, any combination of characters and/or symbols, and/or the like.

As used herein, the term “account token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of account tokens for different individuals or purposes. In some non-limiting embodiments, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

As used herein, the term “computing device” may refer to one or more electronic devices that include one or more processors. A computing device may be a stationary computer or a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also include components to send, receive, and/or process data, such as but not limited to memory, a display device, an input device, a network interface, and/or the like.

As used herein, the term “payment device” may refer to a payment card, such as a credit card, a debit card, a charge card, a gift card, a smartcard, a payroll card, and/or the like, associated with an account identifier of a payment account. In some non-limiting embodiments, the payment device may include volatile and/or non-volatile memory to store information (e.g., an account identifier, a name of the account holder, and/or the like). A payment device may also include a mobile device having an electronic wallet thereon.

As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more devices, such as one or more processors, servers, and computing devices that include software applications, and/or the like.

Some non-limiting embodiments of the present disclosure are directed to systems, methods, and computer program products for analyzing street address data during a transaction to identify the location of a device. In some non-limiting embodiments, a method may include receiving street address data associated with a street address of a payment transaction device or merchant device during a transaction. The street address data may be parsed into a set of discrete character sets (referred to herein as a street address token). A street address token may be any discrete set of one or more characters arranged in a string, array, or any other like data structure. In some non-limiting embodiments, features may be extracted from each street address token. Each street address token may be associated with one or more street address token types based on these extracted features. Street address token type may correspond to features of local, national, and/or international addressing standards (e.g., a building number, a pre-direction, a street name, a street type, a post-direction, an occupancy identifier, an occupancy number, etc.). In some non-limiting embodiments, this analysis of each street address token may occur in series, and be based on the value and/or street address token type of a token in a particular relationship to the street address token (e.g., the value and/or street address token type of the street address token located prior to or after the instant street address token, the features of the instant street address token, etc.).

In some non-limiting embodiments, once each street address token is associated with a particular street address token type, the street address token may be standardized to generate a standardized street address. In some non-limiting embodiments, standardization may result in the generation of a standardized street address including a single string or a set of strings that at least partially correspond to one or more of the street address tokens. In some non-limiting embodiments, the standardized street address may be compared to a database of known street addresses. Each known street address stored may be associated with a geographic position or area (e.g., latitude and longitude coordinates, a zip code, etc.). When a standardized street address is matched with a known street address during a transaction, the geographic position associated with the known street address may be associated with one or more devices engaged in the transaction (e.g., a mobile device, a merchant point-of-sale (POS) system, and/or the like, as identified by a device identifier, network address, and/or the like) and/or the transaction itself (e.g., as identified by a transaction identifier or by some other identifier directly or indirectly corresponding to the transaction).

In this way, the derived geographic position of the payment transaction device(s) may be derived and later used to determine whether a given transaction is a valid transaction. Additionally, or alternatively, the derived geographic position may be used to cause one or more actions to be taken (e.g., to process a transaction, to deny a transaction, to suspend action on an account, to transmit a message to a device before, during, or after the transaction, etc.).

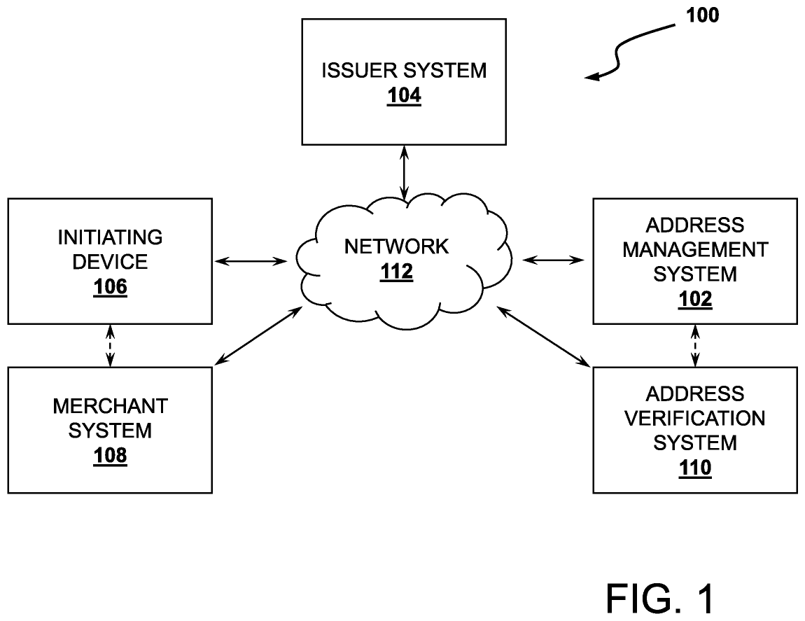

Referring now to FIG. 1, a system 100 for determining a street address based on transaction data is shown according to a non-limiting embodiment. As shown, the system 100 includes an address management system 102, an issuer system 104, an initiating device 106, a merchant system 108, an address verification system 110, and a network 112. The address management system 102, issuer system 104, initiating device 106, merchant system 108, and/or address verification system 110 may interconnect (e.g., establish a connection to directly or operably communicate) via wired connections, wireless connections, or a combination of wired and wireless connections, to any or all of the corresponding components of the system 100.

With continued reference to FIG. 1, the address management system 102 may include one or more devices capable of communicating and/or receiving information to and/or from the issuer system 104, initiating device 106, merchant system 108, and/or address verification system 110 via the network 112. For example, the address management system 102 may include one or more computing devices, such as a server (e.g., a transaction processing server), a group of servers, and/or other similar devices. In some non-limiting embodiments, the address management system 102 may be associated with and/or operated by a financial institution (e.g., an issuer institution) and/or a transaction service provider, as described herein. In some non-limiting embodiments, the address management system 102 may include the address verification system 110. The address verification system 110 may be a component of the address management system 102 or a stand-alone component in direct communication or operable communication (e.g., via the network 112) with the address management system 102.

The issuer system 104 may include one or more devices capable of communicating and/or receiving information to and/or from the address management system 102, initiating device 106, merchant system 108, and/or address verification system 110 via the network 112. For example, the issuer system 104 may include one or more computing devices, such as a server, a group of servers, and/or other similar devices. In some non-limiting embodiments, the issuer system 104 may be associated with an issuer institution that issued a credit account, debit account, credit card, debit card, and/or the like to a user associated with the initiating device 106.

The initiating device 106 may include one or more devices capable of communicating and/or receiving information to and/or from the address management system 102, issuer system 104, merchant system 108, and/or address verification system 110 via the network 112. For example, the initiating device 106 may include a payment device, one or more computing devices, and/or any other system or device configured to initiate a transaction. In some non-limiting embodiments, the initiating device 106 may interconnect (e.g., establish a connection to communicate) with the merchant system 108 via wired connections, wireless connections, or a combination of wired and wireless connections. In some non-limiting embodiments, the initiating device 106 may be part of the merchant system 108, such as one or more components of a POS system. In some non-limiting embodiments, the initiating device 106 may be capable of receiving information (e.g., from the merchant system 108) via a short range wireless communication connection (e.g., a near-field communication (NFC) connection, a radio frequency identification (RFID) communication connection, a Bluetooth® communication connection, and/or the like) or any other form of communication (e.g., a communication routed through a hub or server). In some non-limiting embodiments, the initiating device 106 may be configured to communicate information (e.g., to the merchant system 108) via a short range wireless communication connection or any other form of communication.

The merchant system 108 may include one or more systems or devices capable of communicating and/or receiving information to and/or from the address management system 102, issuer system 104, initiating device 106, and/or address management system 102 via the network 112. For example, the merchant system 108 may include one or more computing devices, such as one or more servers, one or more POS systems, and/or other like systems or devices. In some non-limiting embodiments, the merchant system 108 may include a device capable of communicating and/or receiving information from the initiating device 106 via a network (e.g., the network 112) and/or a wireless communication connection (e.g., an NFC communication connection, an RFID communication connection, a Bluetooth® communication connection, and/or the like). In some non-limiting embodiments, the merchant system 108 may include one or more initiating devices 106. For example, the merchant system 108 may include initiating devices 106 that allow a merchant to communicate information to the address management system 102. In some non-limiting embodiments, the merchant system 108 may include one or more devices, such as computers, computer systems, and/or peripheral devices capable of being used by a merchant to conduct a payment transaction with a user.

The address verification system 110 may include one or more devices capable of communicating and/or receiving information to and/or from the address management system 102, issuer system 104, initiating device 106, and/or merchant system 108 via the network 112. For example, the address verification system 110 may include one or more computing devices, such as a server, a group of servers, and/or other like devices. In some non-limiting embodiments, the address verification system 110 may be associated with a financial institution (e.g., an issuer institution) and/or a transaction service provider, as described herein.

The network 112 may include one or more wired and/or wireless networks. For example, the network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems, devices, and networks illustrated by FIG. 1 are provided as an example. There may be additional devices, systems, and/or networks, fewer devices, systems, and/or networks, different devices, systems, and/or networks, or differently arranged devices, systems, and/or networks than those shown in FIG. 1. Furthermore, two or more devices or systems shown in FIG. 1 may be implemented within a single device or system, or a single device or system shown in FIG. 1 may be implemented as multiple, distributed devices or systems. Additionally, or alternatively, a set of devices or systems (e.g., one or more devices or systems) of the system 100 for determining a street address based on transaction data may perform one or more functions described as being performed by another set of devices or systems of the system 100 for determining a street address based on transaction data.

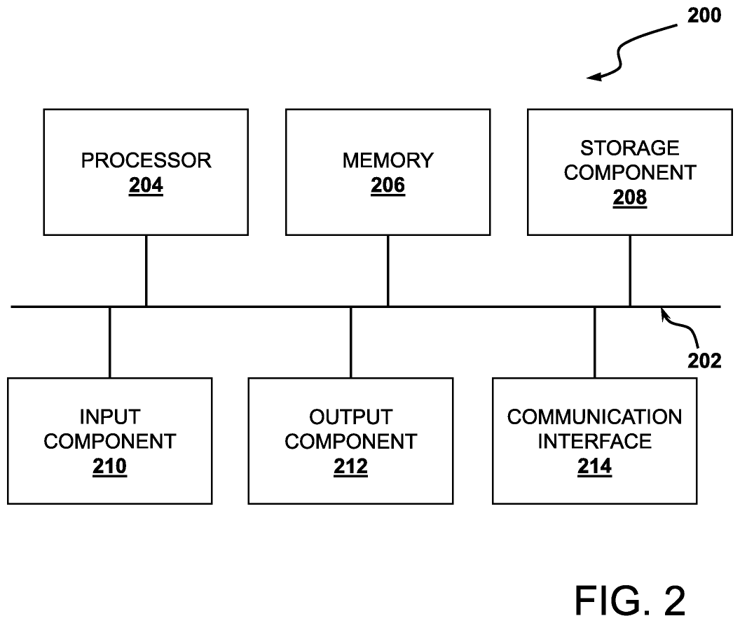

Referring now to FIG. 2, illustrated is a diagram of a device having multiple components, the device referred to generally as computing device 200. The components described with regard to computing device 200 may correspond, all or in part, to components of one or more devices associated with the address management system 102, the issuer system 104, the initiating device 106, and/or the merchant system 108. In some non-limiting embodiments, the address management system 102, issuer system 104, initiating device 106, and/or merchant system 108 may include at least one computing device 200 and/or one or more components of the computing device 200. As illustrated by FIG. 2, the computing device 200 may include a bus 202, a processor 204, memory 206, a storage component 208, an input component 210, an output component 212, and a communication interface 214.

The bus 202 may include a component that permits communication between the components of the computing device 200. In some non-limiting embodiments, the processor 204 may be implemented in hardware, firmware, or a combination of hardware and software. For example, the processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA) and/or an application-specific integrated circuit (ASIC), etc.) that can be programmed to perform one or more functions. The memory 206 may include random access memory (RAM), read-only memory (ROM), and/or another type of dynamic or static storage device (e.g., flash memory, magnetic memory, optical memory, etc.) that stores information and/or instructions for use and/or execution on the processor 204.

The storage component 208 may store information and/or software (e.g., executable instructions) related to the operation and use of the computing device 200. For example, the storage component 208 may include a hard disk (e.g., a magnetic disk, an optical disk, a magneto-optic disk, a solid state disk, etc.), a compact disk (CD), a digital versatile disc (DVD), a floppy disk, a cartridge, a magnetic tape, and/or another type of computer-readable medium, along with a corresponding drive.

The input component 210 may include a component that permits the computing device 200 to receive information, such as via user input (e.g., a touch screen display, a keyboard, a keypad, a mouse, a button, a switch, a microphone, etc.). Additionally, or alternatively, the input component 210 may include a sensor for sensing information (e.g., a global positioning system (GPS) component, an accelerometer, a gyroscope, an actuator, etc.). The output component 212 may include a speaker, one or more light-emitting diodes (LEDs), etc.

The communication interface 214 may include a transceiver-like component (e.g., a transceiver, a separate receiver and transmitter, etc.) that enables the computing device 200 to communicate with other devices, such as via wired connections, wireless connections, or a combination of wired and wireless connections. The communication interface 214 may enable the computing device 200 to receive information from another device and/or provide information to another device. For example, the communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

The computing device 200 may perform one or more processes described herein. For example, the computing device 200 may perform processes by executing software instructions on the processor 204. The software instructions may be stored in a computer-readable medium, such as memory 206 and/or the storage component 208. A computer-readable medium (e.g., a non-transitory computer-readable medium) is defined herein as a non-transitory memory device. A memory device includes memory space located inside of a single physical storage device or memory space spread across multiple physical storage devices.

The software instructions may be read into memory 206 and/or the storage component 208 from another computer-readable medium from another device via the communication interface 214. When executed, the software instructions stored in the memory 206 and/or the storage component 208 may cause the processor 204 to perform one or more processes described herein. Additionally, or alternatively, hardwired circuitry may be used in place of, or in combination with, software instructions to perform one or more of the processes described herein. Thus, embodiments described herein are not limited to any specific combination of hardware circuitry and/or software.

The number and arrangement of components shown in FIG. 2 are provided as an example. In some non-limiting embodiments, the computing device 200 may include additional components, fewer components, different components, or differently arranged components than those shown in FIG. 2. Additionally, or alternatively, a set of components (e.g., one or more components) of the computing device 200 may perform one or more functions described as being performed by another set of components of the computing device 200.

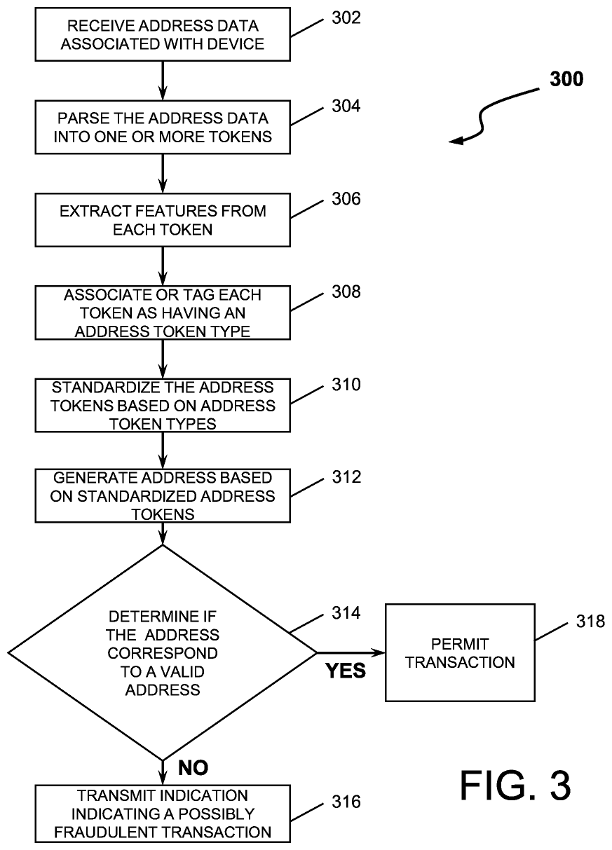

Referring now to FIG. 3, illustrated is a flowchart of a non-limiting embodiment of a process for determining and/or analyzing a physical location of a device during a transaction, referred to generally as process 300. While reference may be made to embodiments including certain devices or types of transactions, it will be understood that these devices and transactions are provided for illustrative purposes only and are not intended to limit the scope of the present disclosure to such devices and/or transactions. It will also be understood that the actions described herein may be performed by executing instructions on one or more processors of one or more of the devices or systems illustrated in the system 100 shown in FIG. 1. For example, in some non-limiting embodiments, one or more of the steps of process 300 may be performed (e.g., completely, partially, etc.) by the address verification system 110 (e.g., one or more devices of the address verification system 110). In some non-limiting embodiments, one or more of the steps of process 300 may be performed (e.g., completely, partially, etc.) by another device or a group of devices separate from or including the address verification system 110, such as the issuer system 104 (e.g., one or more devices of the issuer system 104), the initiating device 106, the merchant system 108 (e.g., one or more devices of the merchant system 108), and/or the address management system 102. In some non-limiting embodiments, the address verification system 110 and the address management system 102 may be combined or otherwise associated with one another in a larger computing system maintained by a financial institution, a transaction service provider, and/or an issuer.

In some non-limiting embodiments, the initiating device 106 may engage the merchant system 108 and initiate a transaction. For example, a user may initiate a transaction at a POS system, an automated teller machine (ATM), a fuel pump, and/or at any other merchant system, using a payment device. The initiating device 106 may communicate or be read to collect certain data stored on the initiating device 106, such as account identifying information (e.g., a PAN) to associate a payment account maintained by an issuer with the transaction to satisfy requirements of the transaction. The merchant system 108 may also receive, generate, or determine other transaction data relating to the transaction, such as a transaction value, transaction time, transaction date, merchant identifier, street address data, and/or the like. Once the merchant system 108 receives, generates, and/or determines some or all of the transaction data, the merchant system 108 may transmit the transaction data to the address management system 102.

The address verification system 110 may receive the transaction data from the merchant system 108 (block 302). In some non-limiting embodiments, the transaction data may include street address data communicated as textual data (e.g., one or more strings of characters) or via other suitable data structures which enable the communication of text. The street address data may include a series of characters such as upper and lower case letters, numerals, symbols, whitespace, and the like. In non-limiting embodiments, the address data is received in raw or unstandardized form, and may include any combination of whitespaces, capital letters, lower case letters, numerals, symbols, and/or the like. For example, address data may be received that reads “100 East 45th St. Apt. #11 B,” “100 E 45th Street Unit 11 B,” etc.

The address verification system 110 may parse the street address data into one or more street address tokens (block 304). For example, the string associated with the street address data may be analyzed and separated into one or more sub-strings based on a type of character and a position of each character at varying points along the string (e.g., whether the character is a whitespace character, a special character, and/or is positioned relative to a whitespace character and/or a special character, etc.). In some non-limiting embodiments, the order of the street address tokens is maintained throughout process 300. Each sub-string may then be associated with a discrete street address token. For example, the string “100 East 45th St. Apt. #11 B” may be parsed into the following street address tokens: “100,” “East,” “45th,” “St.,” “Apt.,” “#,” “11B”.

In some non-limiting embodiments, the address verification system 110 may pre-process the string associated with the street address data and/or the strings associated with each street address token. For example, one or more characters or substrings may be modified (e.g., transitioned from lower case to upper case, replaced, annotated, etc.) to match a predetermined addressing convention. Duplicative characters may also be removed such as, for example, repeated whitespace characters. For example, the above-noted address tokens may be standardized as follows: “100,” “EAST,” “45TH,” “ST,” “APT,” “#,” “11,” “B”. In some non-limiting embodiments, certain predefined characters (e.g., a “#,” “&,” etc.) may be removed and/or replaced by strings or other characters.

Some or all of the street address tokens may be analyzed to extract features of each token (block 306). Extracting features from each street address token may include identifying features based on feature criteria. Feature criteria may include one or more of: the existence or non-existence of predetermined sequences of characters within each discrete street address token (e.g., “STREET,” “APT,” “EAST”), the value of a previous or next street address token (and, in the case of the first and last street address token, the non-existence of an previous or next discrete street address token, respectively), the pattern of characters associated within the street address token (e.g., if the street address token includes exclusively numbers, letters, is patterned in a predetermined configuration (e.g., numbers followed by letters, letters followed by numbers), and/or the like), and the pattern of characters associated with the previous and/or next street address token.

In some non-limiting embodiments, a machine learning algorithm may be executed on a plurality of processed (e.g., already standardized) street address tokens (e.g., a training data set) to generate a classification model including one or more features (e.g., predetermined character sets, predetermined character set patterns, etc.). The classification model may be applied to each street address token for a given street address to generate one or more street address token features for each street address token. The street address token features may then be associated with the street address token. It will be understood that the machine learning algorithm may be configured to, upon execution on the pre-standardized street addresses, select a subset of street address tokens to form the classification model (e.g., the top 5%, 10%, 20%, etc., of street address tokens may be selected as seeds for a clustering algorithm) for inclusion in the classification model.

In some non-limiting embodiments, the street address tokens may be assigned or tagged with a particular street address component or street address token type (block 308). For example, street address token types may be assigned based on the features extracted from each address token (see block 306). In some non-limiting embodiments, street address token types may include, without limitation, a house number, a pre-direction, a street name, a street type, a post-direction, an occupancy identifier, and an occupancy number. In some embodiments, each set of street address tokens associated with a street address may include street address tokens having some or all of the above-noted address token types. For example, a set of street address tokens, such as “123,” “SMITH,” “ST,” includes a building number, a street name, and a street type. Alternatively, a set of address tokens, such as “123,” “EAST,” “49TH,” “ST,” “STE,” “100RW,” includes a house number, a pre-direction, a street name, a street type, an occupancy identifier, and an occupancy number, respectively. It will be appreciated that additional or fewer parameters may be part of a street address.

In some non-limiting embodiments, a predetermined machine learning algorithm may be executed on a plurality of processed (e.g., already standardized) street address tokens (e.g., a training data set) to generate a classification model for classifying each street address token with a street address token type. The classification model may be applied to each street address token of a street address to generate a street address token type for each street address token. Each street address word or substring may be associated or tagged with a corresponding street address token type. It will be understood that the machine learning algorithm be configured to, upon execution on plurality of pre-standardized street addresses, select a subset of tags (e.g., the top 5%, 10%, 20%, etc., of street address tokens may be selected as the seeds for a clustering algorithm) for inclusion in the classification model. In some non-limiting embodiments, street address tokens that are not identified as corresponding to a predetermined street address token type (e.g., a street name having a unique sequence of characters such as, without limitation, “MANHATTAN”) are identified as street names and associated with the corresponding street address token type.

In some non-limiting embodiments, each street address token for a given street address may be analyzed serially (e.g., from first to last, or vice versa) to determine and associate the street address token with an appropriate street address token type. In some non-limiting embodiments, street address tokens may be analyzed serially and tagged only based on extracted features and/or the street address token tag of the street address token. In some non-limiting embodiments, each street address token for a given street address may be analyzed in parallel. In some non-limiting embodiments, each street address token may be analyzed in a combination of parallel and serial steps.

In some non-limiting embodiments, each street address token may be associated or tagged as having a street address token type based one or more of the following: the extracted features (see block 306) of the instant street address token, the extracted features of the street address token(s) positioned before and/or after the instant street address token, an identified street address token type and/or an assumed street address token type of one or more address tokens from among the set of street address tokens (apart from the instant street address token), the relative relationship between a street address token associated with one or more particular street address token types and the instant street address token, and/or the lack of a street address token located before or after the instant street address token. As used herein, an assumed street token type is a street address token type having a probability of being an appropriate street token type, the probability being greater than a predetermined threshold. For example, a first street address token may, by virtue of its position within the set of street address tokens, be assigned a first probability that the first street address token is a building number (e.g., a house number). The first probability may be greater or less than a probability threshold for that particular street address token type, and may be increased or reduced based on analysis of the other street address tokens within the street address token set.

In some non-limiting embodiments, the street address tokens may be standardized based on the street address token type of the street address tokens (block 310). Standardization may include, without limitation, converting the string associated with a street address token to a standardized string based on the street address token type and the value of the street address token. For example, street address tokens tagged as having a street address token type of “street type” may be matched with a street type from a predetermined set of street types (e.g., “STREET” may be matched and changed to “ST,” “AVENUE” may be matched and changed to “AVE,” etc.).

In some non-limiting embodiments, a standardized address may be generated (block 312). The standardized address may include the series of standardized street address tokens. In some non-limiting embodiments, the strings of the standardized street address tokens may be combined to form a single address string (e.g., “100,” “SMITH,” “ST,” may be combined to form “100 SMITH ST”).

In some non-limiting embodiments, the standardized street address tokens and/or the standardized street address may be analyzed to determine if the standardized street address tokens and/or standardized street address correspond to a valid address (block 314). For example, the standardized address may be compared or matched, using exact and native approximate string matching techniques, to standardized street addresses stored in a database of known addresses. In some non-limiting embodiments, the database of known addresses may include sets of standardized street address tokens and/or standardized street addresses which may have been standardized in a manner similar to processes described above (see blocks 302-312). The standardized address may then be matched to a known address in the database. In a case where the standardized address is not matched with a known address (“NO” at block 314), an indication may be transmitted (e.g., a payment transaction fraud parameter) to indicate that the transaction may be fraudulent (block 316). Alternatively, in a case where the standardized address is matched with a known address, a known location associated with the known address may be associated with the standardized address and/or the transaction.

In some non-limiting embodiments, the known location associated with the transaction may be analyzed to determine if the known location corresponds to a valid address. For example, a merchant system managed by a merchant may transmit address data that is analyzed (blocks 302-312) and associated with a particular location. In the case where the location of the merchant system is determined not to match an established location (e.g., a location derived from and transmitted to the address verification system 110 via a GPS device of a merchant system, a location derived and transmitted to the address verification system 110 via a GPS device of the initiating device 106, location data of an account holder of the initiating device 106 (e.g., a billing address, etc.), location data associated with a merchant account corresponding to the merchant system (e.g., a billing address, a correspondence address, a store location, etc.)), the standardized address may be determined to be invalid (“NO” at block 314). Where the standardized address is determined to be invalid, the transaction may be identified as potentially fraudulent. A signal may then be generated and transmitted to one or more of the devices of the environment 100 to indicate that the transaction may be a fraudulent transaction (block 316). In a case where the address is determined to correspond to a valid address (“YES” at block 314), the transaction is determined to be authorized and/or permitted (block 318).

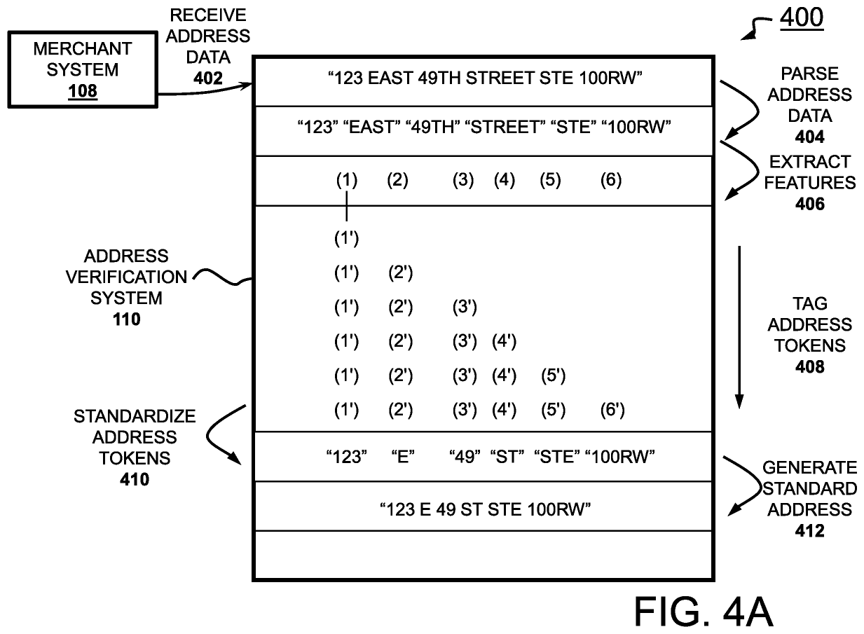

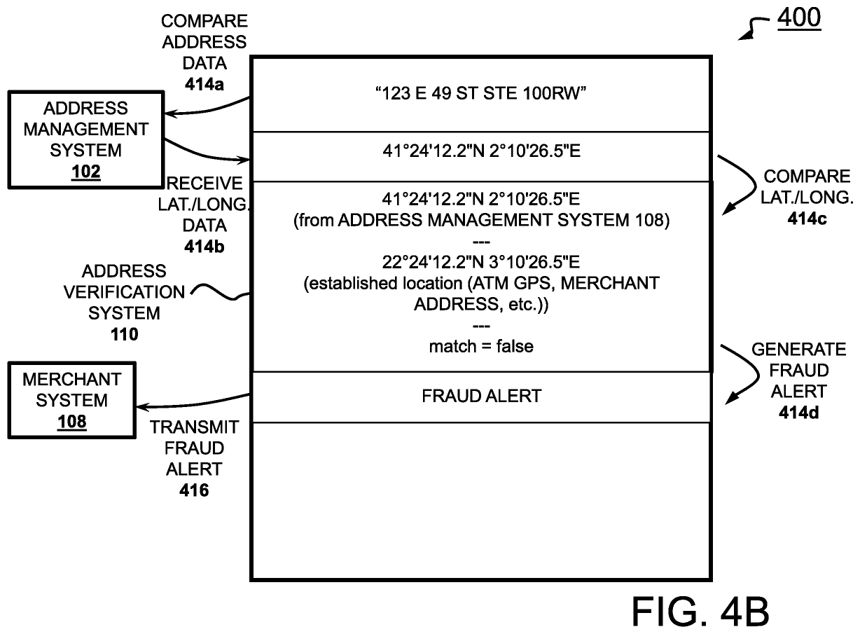

FIGS. 4A and 4B illustrate a non-limiting example of a system and method for determining a street address based on transaction data. In this example, an address input (“123 EAST 49TH STREET STE 100RW”) is received from the merchant system 108 at the address verification system 110 (402). Upon receipt of the address input, the address verification system 110 executes instructions which parse the address input into a set of street address tokens (“123,” “EAST,” “49TH,” “STREET,” “SUITE,” “100RW”) (404). The street address tokens are analyzed to extract features (1)-(6) associated with each address token (406). For example, an address token may be identified as containing only numbers (e.g., (1)=“123”), indicating that the probability that the instant address token is a “building number” or “occupancy number” is increased. In another example, an address token may be identified as containing a specific sequence of characters (e.g., “STREET”) and, as such, there is an increased probability that the instant address token is associated with a “street type” feature.

The address tokens are then tagged with a corresponding street address token type (1′)-(6′) (408). For example, the first address token (with a value of “123”) may be identified as the first street address token. Based on this feature, the first street address token may be identified as having a certain probability of being a building number. Additionally, the probability that the first street address token is a building number may be increased or decreased given that the characters forming the first address token are all number characters. Once the probability that the instant address token is associated with a particular address token type (e.g., a building number, pre-direction, etc.) exceeds a predetermined threshold the street address token is tagged as having an address token type (shown as (1′)), and the next street address token is analyzed. It will be understood that, should a later street address token from the set cause the probability that the previous street address token is accurately tagged to be reduced, the previous street address token may be analyzed again and tagged with an appropriate address token type.

Once each street address token is tagged with a street address token type, each street address token is standardized (410). For example, as shown, the second street address token (“EAST”), having been tagged as a “pre-direction (1′),” is associated with a specific pre-direction and the characters changed to a standard character (“E”) for that pre-direction. In some non-limiting embodiments, once all the street address tokens are standardized, the set of street address tokens may be referred to as a standardized address. In some non-limiting embodiments, the standardized street address tokens are combined to generate a standardized address (412) in any type of data structure.

The standardized address may be transmitted to the address management system 102 for comparison to a list of known addresses maintained in the address management system 102 (414a). In the case where the standardized address matches a known address, the corresponding location information is transmitted to the address verification system 110 (414b). The received location information may then be compared to an established location (e.g., a location derived from a received GPS signal of a GPS unit embedded in the ATM, an address associated with an Internet Protocol (IP) address assigned to the ATM, etc.) to determine if the received location information matches the established location (414c). As shown, the location information associated with the standardized address does not match the established location, and in response to this determination a fraud alert is generated (414d). If the location information and established location were determined to have matched, a fraud alert may not have been generated. The fraud alert may be transmitted to the merchant system 108 (e.g., the ATM) which may take remedial action (e.g., prevent a transaction from being approved) (416). It will be understood that the fraud alert may be transmitted to any of the components in the system 100 such as the issuer system 104, the initiating device 106, the merchant system 108, and/or the address management system 102.

Although non-limiting embodiments have been described in detail for the purpose of illustration based on what are currently considered to be the most practical and preferred embodiments, it is to be understood that such detail is provided solely for that purpose and that the present disclosure should not be limited to the disclosed embodiments. On the contrary, the present disclosure is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method for determining a street address based on transaction data, comprising:
receiving, with at least one processor, transaction data associated with a payment transaction;
determining, with at least one processor, street address data associated with a street address from the transaction data associated with the payment transaction;
tokenizing, with at least one processor, the street address data associated with the street address into a plurality of street address tokens;
extracting, with at least one processor, street address token features for each of the plurality of street address tokens using a machine learning algorithm;
tagging, with at least one processor, each of the plurality of street address tokens using the machine learning algorithm based on the street address token features to provide a plurality of tagged street address components;
determining, with at least one processor, whether each of the plurality of tagged street address components correspond to a plurality of predetermined street address components; and
communicating, with at least one processor, an indication of a payment transaction fraud parameter based on determining whether each of the plurality of tagged street address components correspond to the plurality of predetermined street address components.

2. The method of claim 1, wherein receiving the transaction data associated with the payment transaction comprises:
receiving a payment transaction message comprising the transaction data associated with the payment transaction,
wherein determining the street address data associated with the street address from the transaction data associated with the payment transaction comprises:
determining the street address data with the street address from a merchant name field of the payment transaction message.

3. The method of claim 1, wherein determining whether each of the plurality of tagged street address components correspond to the plurality of predetermined street address components comprises:
determining whether each of the plurality of tagged street address components correspond to the plurality of predetermined street address components based on a combination of exact and native approximate string matching techniques.

4. The method of claim 1, further comprising:
standardizing the plurality of street address tokens before extracting the street address token features for each of the plurality of street address tokens.

5. The method of claim 4, further comprising:
assigning the indication of a payment transaction fraud parameter to the payment transaction based on determining that each of the plurality of tagged street address components do not correspond to the plurality of predetermined street address components; and
wherein communicating the indication of a payment transaction fraud parameter comprises:
communicating the indication of a payment transaction fraud parameter based on assigning the indication of a payment transaction fraud parameter to the payment transaction.

6. The method of claim 1, wherein determining the street address data associated with the street address from the transaction data associated with the payment transaction comprises:
determining the street address data associated with the street address of a point-of-sale (POS) terminal from the transaction data associated with the payment transaction.

7. The method of claim 1, further comprising:
communicating street address data associated with a street address of a merchant based on determining that each of the plurality of tagged street address components correspond to the plurality of predetermined street address components.

8. The method of claim 1, wherein extracting the street address token features for each of the plurality of street address tokens using the machine learning algorithm comprises:
determining a value of a first street address token; and
determining a value of a second street address token, wherein the second street address token is adjacent the first street address token.

9. The method of claim 1, wherein extracting the street address token features for each of the plurality of street address tokens using the machine learning algorithm comprises:
determining if a first street address token corresponds to a direction of a street address;
determining if a second street address token corresponds to a street type of a street address; and
determining if a third street address token corresponds to an occupancy type of a street address.

10. A system for determining a street address based on transaction data, comprising at least one server computer including at least one processor, the at least one server computer programmed or configured to:
receive transaction data associated with a payment transaction;
determine street address data associated with a street address from the transaction data associated with the payment transaction;
tokenize the street address data associated with the street address into a plurality of street address tokens;
extract street address token features for each of the plurality of street address tokens using a machine learning algorithm;
tag each of the plurality of street address tokens using the machine learning algorithm based on the street address token features to provide a plurality of tagged street address components;
determine whether each of the plurality of tagged street address components correspond to a plurality of predetermined street address components; and
communicate an indication of a payment transaction fraud parameter based on determining whether each of the plurality of tagged street address components correspond to the plurality of predetermined street address components.

11. The system of claim 10, wherein receiving the transaction data associated with the payment transaction comprises:
receiving a payment transaction message comprising the transaction data associated with the payment transaction,
wherein determining the street address data associated with the street address from the transaction data associated with the payment transaction comprises:
determining the street address data with the street address from a merchant name field of the payment transaction message.

12. The system of claim 10, wherein determining whether each of the plurality of tagged street address components correspond to the plurality of predetermined street address components comprises:
determining whether each of the plurality of tagged street address components correspond to the plurality of predetermined street address components based on a combination of exact and native approximate string matching techniques.

13. The system of claim 10, wherein the at least one server computer is further programmed or configured to: standardize the plurality of street address tokens before extracting the street address token features for each of the plurality of street address tokens.

14. The system of claim 13, wherein the at least one server computer is further programmed or configured to: assign the indication of a payment transaction fraud parameter to the payment transaction based on determining that each of the plurality of tagged street address components do not correspond to the plurality of predetermined street address components; and
wherein communicating the indication of a payment transaction fraud parameter comprises:
communicating the indication of a payment transaction fraud parameter based on assigning the indication of a payment transaction fraud parameter to the payment transaction.

15. The system of claim 10, wherein determining the street address data associated with the street address from the transaction data associated with the payment transaction comprises:
determining the street address data associated with the street address of a point-of-sale (POS) terminal from the transaction data associated with the payment transaction.

16. The system of claim 10, wherein the at least one server computer is further programmed or configured to: communicate street address data associated with a street address of a merchant based on determining that each of the plurality of tagged street address components correspond to the plurality of predetermined street address components.

17. The system of claim 10, wherein extracting the street address token feature for each of the plurality of street address tokens using the machine learning algorithm comprises:
determining a value of a first street address token; and
determining a value of a second street address token, wherein the second street address token is adjacent to the first street address token.

18. The system of claim 10, wherein extracting the street address token feature for each of the plurality of street address tokens using the machine learning algorithm comprises:
determining if a first street address token corresponds to a direction of a street address;
determining if a second street address token corresponds to a street type of a street address; and
determining if a third street address token corresponds to an occupancy type of a street address.

19. A computer program product for determining a street address based on transaction data, comprising at least one non-transitory computer-readable medium including program instructions that, when executed by at least one processor, cause the at least one processor to:
receive transaction data associated with a payment transaction;
determine street address data associated with a street address from the transaction data associated with the payment transaction;
tokenize the street address data associated with the street address into a plurality of street address tokens;
extract street address token features for each of the plurality of street address tokens using a machine learning algorithm;
tag each of the plurality of street address tokens using the machine learning algorithm based on the street address token features to provide a plurality of tagged street address components;
determine whether each of the plurality of tagged street address components correspond to a plurality of predetermined street address components; and
communicate an indication of a payment transaction fraud parameter based on determining whether each of the plurality of tagged street address components corresponds to the plurality of predetermined street address components.

20. The computer program product of claim 19, wherein extracting the street address token feature for each of the plurality of street address tokens using the machine learning algorithm comprises:
determining a value of a first street address token; and
determining a value of a second street address token, wherein the second street address token is adjacent to the first street address token.
